(19) United States
(12) Patent Application Publication
(10) Pub. No.: US 2024/0415042 A1
(43) Pub. Date: Dec. 19, 2024

(54) Tractor Drawbar Adapter

(71) Applicant: Mark Bernegger, West Point, MS (US)

(72) Inventor: Mark Bernegger, West Point, MS (US)

(21) Appl. No.: 18/337,266

(22) Filed: Jun. 19, 2023

(51) Int. Cl. A01B 59/00

(52) U.S. Cl. CPC A01B 59/002

(57) ABSTRACT

The present invention introduces a tractor drawbar adapter designed to enhance hitching compatibility between tractors and vehicles. The adapter features a first end that effortlessly slides over the tractor drawbar and securely locks in position using a lock pin or drop pin. At the opposite end, a second end with different dimensions is provided to accommodate a receiver hitch commonly found in vehicles. The first end measures 1 inch, while the second end measures 2 inches, ensuring versatility and compatibility with various drawbars and receiver hitches. The receiver hitch, when attached, includes a ball mount on its opposing end, enabling seamless connection with implements or trailers. Additionally, the adapter incorporates a locking mechanism to firmly secure the receiver hitch, providing stability during towing operations. This innovative solution streamlines the process of connecting tractors to vehicles, offering improved efficiency and safety in agricultural tasks.

### FIELD OF INVENTION

The present invention relates to agricultural machinery or equipment, specifically to a tractor drawbar adapter designed to facilitate seamless and adjustable compatibility with receiver hitches commonly used in vehicles.

### BACKGROUND OF THE INVENTION

Tractors are widely utilized in agricultural operations for towing and powering various implements and equipment. A crucial component of tractors is the drawbar, which provides a means for connecting and towing implements behind the tractor. However, conventional drawbars often lack compatibility with the standardized receiver hitches commonly found on vehicles, limiting the versatility and convenience of hitching operations.

To address this compatibility issue, tractor drawbar adapters have been developed. These adapters serve as intermediary components, allowing for the seamless connection between tractor drawbars and receiver hitches. By bridging the gap between different hitching systems, these adapters enable tractors to utilize a wider range of implements and trailers designed for vehicle receiver hitches.

Receiver hitches, commonly installed on vehicles, are standardized and widely used, featuring a receptacle capable of receiving various hitching accessories. These hitches often incorporate a ball mount on one end, facilitating the secure attachment of implements or trailers.

There is need for an improved tractor drawbar adapter that overcomes the limitations of conventional adapters, and which provides an adjustable design with different dimensions at each end, allowing for easy installation on tractor drawbars and compatibility with receiver hitches.

### SUMMARY OF THE INVENTION

The following summary is an explanation of some of the general inventive steps for the device and apparatus in the description. This summary is not an extensive overview of the invention and does not intend to limit its scope beyond what is described and claimed as a summary.

In some aspects, the present invention introduces a novel tractor drawbar adapter with an adjustable receiver hitch, effectively addressing the need for seamless compatibility between tractors and vehicles in hitching operations. The adapter features two ends: a first end designed to slide over the tractor drawbar and securely lock in place using a lock pin or drop pin, and a second end with different dimensions specifically tailored to accommodate a receiver hitch.

With a dimension of 1 inch at the first end and 2 inches at the second end, the adapter ensures broad compatibility with diverse tractor drawbars and receiver hitches commonly found in vehicles. The receiver hitch, typically used in vehicles, incorporates a ball mount on its opposing end, enabling secure attachment of implements or trailers.

To guarantee stability during towing operations, the tractor drawbar adapter integrates a locking mechanism. This mechanism firmly secures the receiver hitch, enhancing safety and efficiency by establishing a dependable connection between the tractor and the attached implement.

By providing adjustable compatibility and a reliable locking mechanism, the present invention revolutionizes the convenience and effectiveness of hitching operations in agricultural settings. Farmers and operators can now effortlessly connect tractors to vehicles, expanding their range of implement options and streamlining their workflow.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1-4 shows various embodiments of the drawbar adapter.

### DETAILED DESCRIPTION OF THE PREFERRED EMBODIMENTS

Hereinafter, the preferred embodiment of the present invention will be described in detail and reference made to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

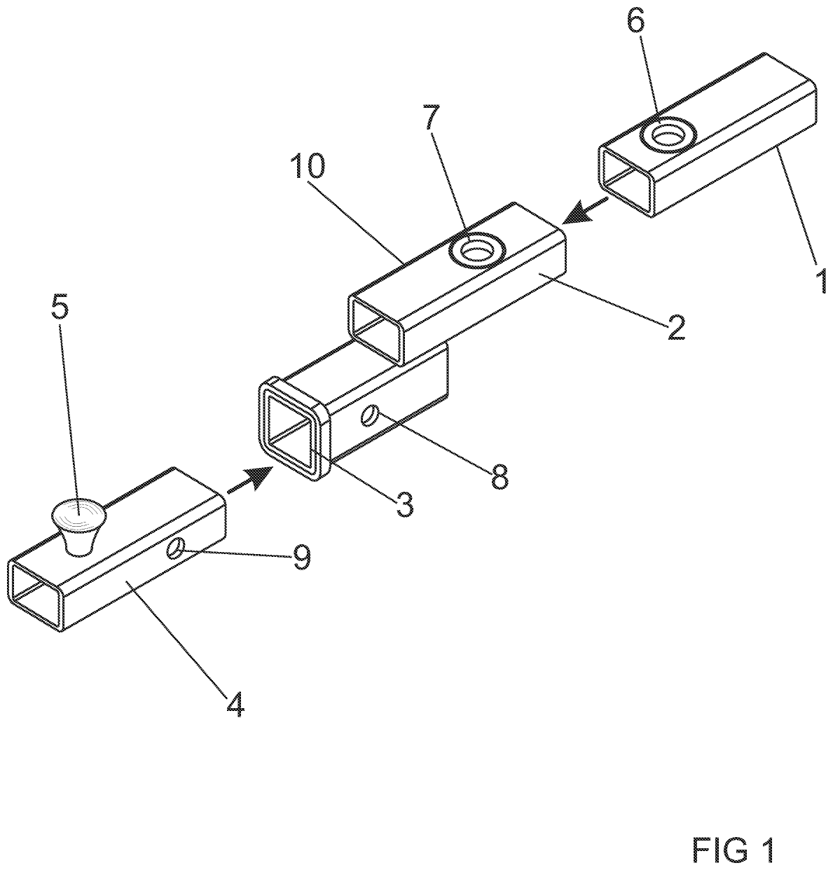

Referring to FIG. 1-4, the present invention provides various embodiments of a drawbar adapter designed to facilitate efficient and secure hitching operations. FIG. 1 illustrates the overall structure of the drawbar adapter 10, which includes a first end 2 and a second end 3. The first end 2 is equipped with a lock pin slot 7, while the tractor drawbar 1 features a corresponding lock pin slot 6. This configuration allows for the secure attachment of the adapter to the tractor drawbar using a lock pin.

On the second end 3 of the drawbar adapter 10, there is a lock pin slot 8, specifically designed to lock the receiver 4. The receiver 4, commonly used in vehicles, provides a receptacle for attaching implements or trailers. To ensure a secure connection, the receiver 4 incorporates a receiver lock pin slot 9, which aligns with the lock pin slot 8 on the adapter. This arrangement enables the receiver to be locked in place using a suitable lock pin.

Furthermore, the receiver 4 is equipped with a receiver ball 5, which serves as a mounting point for implements or trailers. The receiver ball 5 is positioned on the opposing end of the receiver 4, providing a reliable and standardized connection point for hitching operations.

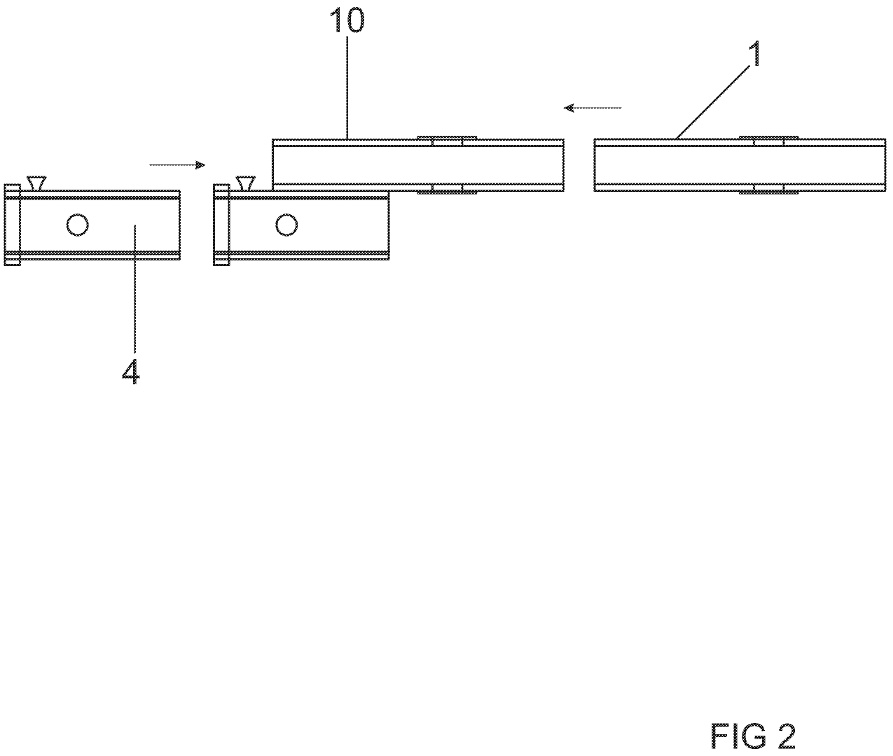

FIG. 2 presents a sectional side view, showcasing the interrelation between the receiver 4, the drawbar adapter 10, and the tractor drawbar 1. This view highlights the secure attachment of the adapter to the tractor drawbar, ensuring stability during towing.

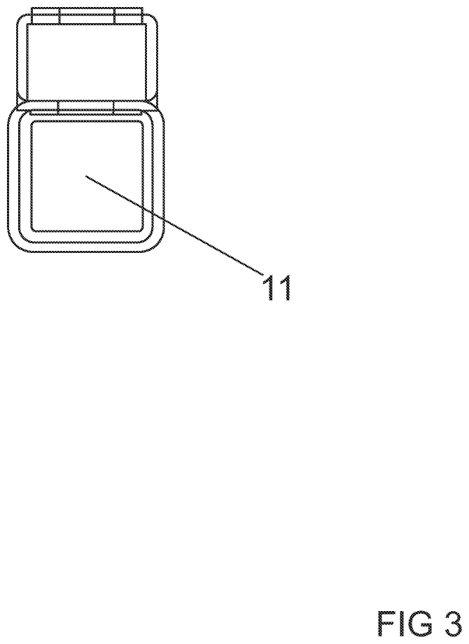

In FIG. 3, a sectional view of the first end 2, denoted as 11, is depicted. This view provides a detailed illustration of the construction and dimensions of the first end of the drawbar adapter.

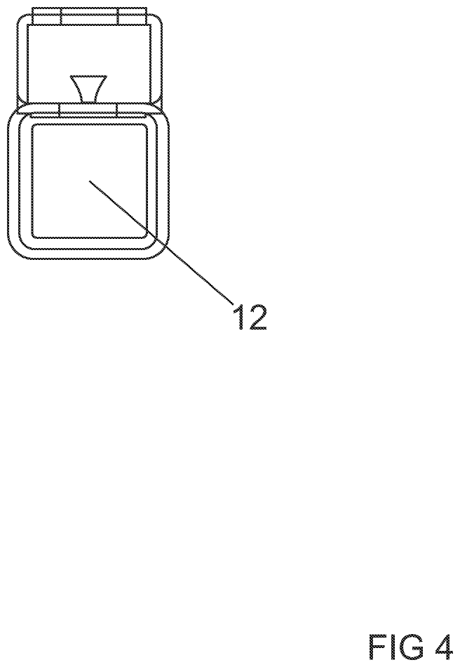

FIG. 4 offers a sectional view of the second end 3, denoted as 12. This view provides a closer look at the structure and dimensions of the second end of the drawbar adapter, which is specifically designed to accommodate the receiver lock pin slot 8.

The drawbar adapter, with its adjustable receiver hitch and locking mechanisms, enables seamless compatibility between tractors and vehicles. It allows for the secure connection of implements or trailers, enhancing safety and efficiency in agricultural operations. The various embodiments depicted in FIG. 1-4 highlight the versatility and adaptability of the drawbar adapter, making it a valuable tool for farmers and operators in their hitching endeavors.

The drawbar adapter operates by following a step-by-step process. Firstly, the adapter is positioned near the tractor drawbar and the desired receiver hitch. The first end of the drawbar adapter, designed to fit over the tractor drawbar with dimensions preferably measuring 1 inch, is slid onto the drawbar. The lock pin slot on the first end aligns with the corresponding lock pin slot on the tractor drawbar. To secure the adapter in place, a lock pin or drop pin is inserted through these aligned slots, creating a strong and reliable connection between the adapter and the drawbar.

Next, the receiver hitch is attached to the second end of the drawbar adapter. The second end, with dimensions preferably measuring 2 inches, is specifically designed to accept a receiver hitch. The receiver hitch, commonly used in vehicles, is positioned near the second end of the adapter. The lock pin slot on the second end aligns with the corresponding slot on the receiver hitch. A lock pin is inserted through these aligned slots, firmly attaching the receiver hitch to the drawbar adapter.

Once the receiver hitch is locked in place, the receiver ball, located on the opposite end of the receiver hitch, serves as a standardized connection point. Implements or trailers can be attached to the receiver ball, allowing for a secure and stable connection during towing operations.

The drawbar adapter's design and locking mechanisms ensure compatibility and safety when connecting tractors and vehicles. It expands the range of available implements and optimizes efficiency in agricultural tasks by providing a reliable and versatile hitching solution.

It is important to note that the invention is intended to embrace all alternatives, modifications, equivalents and variations that are within the spirit and scope of the disclosed subject matter. The invention is designed to be flexible and adaptable, so that it can be used in a variety of contexts. Additionally, the invention can be used with different devices, and can be customized to suit different user preferences.

### INDUSTRIAL APPLICATION

The present invention has significant industrial applications in the agricultural and transportation sectors. In agricultural settings, the drawbar adapter offers enhanced versatility and convenience in hitching operations. Farmers and operators can utilize a wider range of implements and trailers designed for receiver hitches commonly found in vehicles, expanding their capabilities and improving productivity. The secure connection facilitated by the adapter's locking mechanisms ensures safety during towing operations, reducing the risk of accidents or damage. Additionally, the drawbar adapter's adjustable design accommodates different tractor drawbars, making it applicable to various tractor models and configurations. In the transportation sector, the drawbar adapter allows for seamless compatibility between tractors and vehicles, enabling efficient transfer of goods and equipment. Overall, the invention's industrial applications contribute to improved efficiency, flexibility, and safety in agricultural and transportation operations.

What is claimed is:

1. A tractor drawbar adapter comprising:
a first end adapted to slide over a tractor drawbar; and
a second end having a different dimension from the first end, wherein the second end is adapted to accept a receiver hitch.

2. The tractor drawbar adapter of claim 1, further comprising a lock pin or drop pin configured to secure the first end in a locked position on the tractor drawbar.

3. The tractor drawbar adapter of claim 1 or claim 2, wherein the first end has a dimension of 1 inch.

4. The tractor drawbar adapter of claim 1, wherein the second end has a dimension of 2 inches.

5. The tractor drawbar adapter of claim 1, wherein the receiver hitch accepted by the second end comprises a ball mount on the end opposite to the end accepted by the second end.

6. The tractor drawbar adapter of claim 1, wherein the receiver hitch is of the type commonly used in vehicles.

7. The tractor drawbar adapter of claim 1, further comprising a locking mechanism configured to secure the receiver hitch in the second end of the adapter.

8. A method of providing a tractor drawbar adapter, comprising:
providing a first end adapted to slide over a tractor drawbar; and
providing a second end with a different dimension from the first end, wherein the second end is adapted to accept a receiver hitch.

9. The method of claim 8, further comprising securing the first end in a locked position on the tractor drawbar using a lock pin or drop pin.

10. The method of claim 8 or claim 9, wherein the first end has a dimension of 1 inch.

11. The tractor drawbar adapter of claim 1, wherein the second end has a dimension of 2 inches.

12. The method of claim 8, wherein the receiver hitch accepted by the second end comprises a ball mount on the end opposite to the end accepted by the second end.

13. The method of claim 8, wherein the receiver hitch is of the type commonly used in vehicles.

14. The method of claim 8, further comprising a locking mechanism configured to secure the receiver hitch in the second end of the adapter.
